(19) United States
(12) Patent Application Publication
(10) Pub. No.: US 2022/0048629 A1
(43) Pub. Date: Feb. 17, 2022

(54) Seating System for a Passenger Aircraft, Method and Computer-Implementable Program Product

(71) Applicant: AIRCRAFT CABIN MODIFICATION GMBH, Memmingen (DE)

(72) Inventor: Arash Noshari, Hamburg (DE)

(21) Appl. No.: 17/274,752

(22) PCT Filed: Sep. 20, 2019
(86) PCT No.: PCT/EP2019/075366

§ 371 Date: Mar. 9, 2021

(30) Foreign Application Priority Data
Sep. 21, 2018 (EP) 18196096.4

(51) Int. Cl. B64D 11/06; G08B 21/04

(52) U.S. Cl. CPC B64D 11/0607; G08B 21/0423; G08B 21/0461

(57) ABSTRACT

The invention relates to a seating system (10) for a passenger aircraft, comprising
at least one aircraft seat (12) having at least one sensor device (24) which is configured to detect a seat load on the aircraft seat (12) by a passenger (22) sitting thereon,
an evaluation device (32) which is configured to determine a recommendation for a change in a sitting posture depending on the detected seat load and
a display device (36) which is configured to display the recommendation.

Furthermore, the invention relates to a method, a program product and a sleeping system for a passenger aircraft.

### FIELD OF THE INVENTION

The present invention relates to a seating system for a passenger aircraft, a method for operating a seating system and a computer-implementable program product. Additionally, the invention relates to a sleeping system for a passenger aircraft.

### INTRODUCTION

Usually, a passenger aircraft is often chosen as a means of transportation when it comes to covering long distances. Therefore, despite the high, usual flight speed, people often have to spend several hours in the passenger aircraft. Accordingly, there is a high demand to spend this travel time comfortably. Airlines with which the travel experience is perceived as particularly comfortable are therefore usually preferred by passengers.

At the same time, however, it is necessary to keep the cost of a flight low. On the one hand, this can be achieved by a high number of passengers, but this entails that the individual space per passenger in the aircraft is very small. A further important cost driver is aircraft weight. Accordingly, airlines strive to install particularly light and small seats in their aircraft in order to be able to operate cost-efficiently. However, this is often accompanied by the fact that such seats are perceived as uncomfortable when sitting for long periods. As a result thereof, traveling in such a passenger aircraft or sitting on such seats for long periods may be perceived as uncomfortable by the respective passengers.

It should be noted that the human body is not designed for long periods of sitting. Long flights may therefore also cause a not inconsiderable health burden. For example, sitting for long periods in an essentially unchanged position may increase a passenger's likelihood of thromboses, at least temporarily. In addition, each passenger may have a different sitting behavior, wherein certain behaviors may be more of a health burden to the individual and/or may be more uncomfortable than other behaviors in the case of respective seats.

DE 10 2006 042 299 A1 describes a seat occupancy sensor in a seat cushion of a seat element of a passenger aircraft, by means of which a seat occupancy status is detected. This seat occupancy sensor can increase safety because, for example, it can be more quickly checked whether a passenger has fastened his/her seat belt. However, the travel comfort for respective passengers cannot be increased in this way.

### SUMMARY

It is an object of the present invention to improve the travel comfort in a passenger aircraft.

This object is achieved according to the invention by the respective subject-matter of the independent claims. Advantageous embodiments comprising appropriate modifications of the invention are indicated in the respective subclaims, wherein advantageous embodiments of one aspect are to be regarded as advantageous embodiments of respective other aspects and vice versa.

A first aspect of the invention relates to a seating system for a passenger aircraft. The seating system may comprise at least one aircraft seat having at least one sensor device which is configured to detect a seat load on the aircraft seat by a passenger sitting thereon. Furthermore, the seating system may comprise an evaluation device which is configured to determine a recommendation for a change in a sitting posture depending on the detected seat load and a display device which is configured to display the recommendation. The seating system may also be configured as a seat occupancy detection system and/or a sitting posture monitoring system. The aircraft seat is also referred to in the following simply as seat and may also be referred to as chair. For example, the aircraft seat may comprise a seat part, in particular with a seat cushion and/or seat trampoline, a backrest, and/or respective armrests. The display device may also be configured to display a current seat load and/or sitting posture in addition to the recommendation, wherein the evaluation device may also be configured to determine the current sitting posture depending on the detected seat load. In this context, the recommendation may merely comprise that the seated person should change his/her sitting posture. Preferably, however, one or more specific sitting postures which the passenger should adopt next are recommended.

This makes it possible to reliably avoid sitting postures which are stressful to health and/or uncomfortable. The passenger is shown a new recommended sitting posture depending on a current seat load and/or his/her current sitting posture, said new recommended sitting posture being potentially more comfortable and/or less stressful for him/her. Thus, traveling with a passenger aircraft which is equipped with such a seating system can be particularly comfortable for respective passengers.

An aircraft seat has specific requirements. In particular, an aircraft seat must be able to withstand high loads in the event of an accident without breaking, for example, and thus endangering a passenger sitting thereon. The loads to be supported in this connection are also referred to as crash loads for which the aircraft seat must be structurally configured. For example, static accelerations of up to 9 g and dynamic accelerations of up to 16 g must be withstood by the seat during emergency landings. At the same time, however, the aircraft seat must be very light to allow an economical operation of the aircraft. For example, an economy class aircraft seat should be lighter than 20 kg, preferably lighter than 10 kg, wherein this may also comprise respective parts for attachment to the aircraft floor. Additionally, the aircraft seat must also be very robust in terms of use and its lifetime in order to achieve high reliability and long maintenance intervals, which are also important for the economical operation of a passenger aircraft. High space utilization is also important so that the aircraft can accommodate many passengers. To this end, an aircraft seat must be particularly thin, for example.

On account of these requirements, an aircraft seat significantly differs from conventional chairs. In particular, the design of at least some parts of the aircraft seat is fundamentally different from that of conventional chairs. Additionally, due to the aforementioned requirements, extensive adjustment mechanisms are dispensed with in aircraft seats so that an indirect detection of a sitting posture and/or seat load by means of the respective positions of movable parts, such as, for example, a tiltable seat surface, is not possible in the case of aircraft seats and/or is associated with an unacceptably increased effort in the design and an unacceptably increased weight. For example, in the case of conventional aircraft seats, only a backrest is pivotable backwards in a very limited range, which in principle does not allow any conclusions to be drawn about the seat load. Thus, an aircraft seat is preferably rigidly configured and/or only a back part of the aircraft seat is configured to be pivotable relative to a seat part, preferably by not more than 15°, and preferably the remaining parts of the aircraft seat are otherwise rigidly connected to one another. Even in the case of elaborate seats of the first class, which, for example, are adjustable to a sleeping configuration, at least respective seat parts usually are not adjustable in their relative position to a frame of the aircraft seat in order to be able to take the loads of an emergency landing safely and without an unacceptably high weight of the aircraft seat.

An indirect detection of the seat load and/or sitting posture is also made considerably more difficult in the case of aircraft seats, not only because of the lack of adjustment options, but also because of the aircraft movement itself. For example, a commercial aircraft can in principle move and be accelerated in all directions and also rotate almost freely around its three axes without this necessarily meaning a change in seat load and/or sitting posture. For example, a gyrosensor is unsuitable for detecting the seat load in an aircraft, since the aircraft itself can move in all degrees of freedom in space and thus falsifies the measuring results.

Preferably, the seating system comprises a plurality of aircraft seats and one assigned sensor device per aircraft seat. An assignment may be made, for example, by an ID of the respective sensor device and/or the respective seat. One assigned display device and/or a central display device may be provided per sensor device. The respective assigned display device, for example, may only display the recommendation and, where appropriate, further information relating to the assigned seat and/or the passenger of this seat. The central display device, for example, may display all, a plurality of or only assigned detected seat loads, recommendations and other evaluated information. For example, the central display device may alternatively or additionally display whether or not a seat is occupied, for example in a diagram illustrating the aircraft cabin. To this end, the evaluation device may also be configured to determine the seat occupancy depending on the detected seat load. As a further option, the evaluation device may also be configured to determine a respective weight of the passenger. Thus, for example, a total weight of the aircraft payload can be determined more precisely and, correspondingly, the amount of fuel required for a flight. The weight can be stored and weight forecasts for the next flights can be calculated accordingly, in particular if the weight is permanently assigned to a registered passenger.

A respective recommendation and/or current sitting posture may be determined individually for each seat or passenger. One evaluation device per seat, sensor device and/or passenger may be provided for this purpose. Alternatively or additionally, a central evaluation device, for example integrated into the cabin control system, by means of which, for example, an air conditioning system, an infotainment system and/or cabin announcements can be controlled, may be provided, which optionally also determines individual recommendations for respective passengers. The central evaluation device may assign respective seat loads and recommendations, for example by the ID.

The display device, for example, may be configured for an optical, acoustic and/or haptic display. Thus, displaying may be also understood here as outputting. For example, the recommendation for the sitting posture to be adopted by the passenger may be in the form of a pictogram or also an animation which illustrates the change from the current sitting posture to the recommended sitting posture. Alternatively or additionally, the recommendation may be indicated by a vibration, for example of a seat surface of the aircraft seat. Preferably, the display of the recommendation is at least or exclusively visual.

The seating system itself, the sensor device and/or a data transmission between the sensor device and the evaluation device may be activated, for example, by a load on a sensor of the sensor device, centrally by a cabin control system and/or also by starting the aircraft. Alternatively or additionally, the passenger may manually deactivate and/or activate the recommendations and/or the seating system by means of a switch. This switch may be configured, for example, as a mechanical switch on the seat or also as a control element in an infotainment system of the aircraft that can be controlled at the seat.

The seating system also makes it possible to increase the safety in the aircraft since respective sitting postures and seat occupancies can be monitored. For example, in the event of an emergency, a recommendation for a specific sitting posture, such as, for example, the so-called brace position, can be output. The recommendation for a sitting posture can also be modified in the event of turbulence. In addition, it can be detected whether passengers are not in the posture recommended for unsafe flight conditions and then intervened by flight attendants. Therefore, the evaluation device may further preferably be configured to receive respective information about a flight condition and to determine a recommendation for a change in the sitting posture depending on the flight condition and/or seat load.

The recommendation for a change in the sitting posture may be determined by the evaluation device, for example by a tabular comparison of the current and/or previous seat loads. However, the recommendation may also be calculated from these values using a calculation formula, for example. A recommendation for a change in the sitting posture may also be output or determined, for example, if the passenger has remained in substantially a single sitting posture for longer than a predetermined threshold value. The recommendation may also comprise a plurality of sitting postures to be adopted consecutively and/or movement exercises, as well as a recommendation to leave the seat. Leaving the aircraft seat or standing up may also be regarded as changing the sitting posture, for example also in the sense of ending the current sitting posture. The fact that the recommendation has been followed may be detected, for example, by a change in the seat load and may also be displayed. A specific sitting posture may correspond to, for example, specific seat loads, seat load areas and/or seat load centers of gravity.

For example, the seating system may have an additional weight of less than 50 g, in particular less than 30 g, preferably less than 20 g compared to conventional seating systems, which cannot generate a recommendation for a change in the sitting posture. In particular, the sensor device may have a weight of less than 50 g, in particular less than 30 g, preferably less than 20 g. Preferably, the maintenance interval for the seating system is not shorter than 2 years. In the case of a power supply via an energy storage, such as a rechargeable battery or a button cell, the power consumption and the capacity are preferably configured accordingly.

Data transmission between the sensor device, the evaluation device and/or the display device may take place by means of a data transmission device, in particular comprising an A/D converter for converting an analog sensor signal into a digital signal. The seating system is preferably configured to determine where and how the passenger is sitting on the seat and, depending thereon, to determine when and how the passenger should change his/her sitting posture.

The seating system also makes it possible to output recommendations for the sitting posture that correspond to a design of the seat. Thus, for example, sitting postures can be avoided which are usually comfortable and/or less stressful to health, but which are uncomfortable and/or more stressful to health due to the specific design of the seat. Thus, for example, particularly light seat designs become possible which are only unfavorable in specific sitting postures, but still enable enough alternative comfortable sitting postures and/or sitting postures which are unproblematic in terms of health in order to be acceptable for the passenger.

In a further advantageous embodiment of the seating system according to the first aspect of the invention, it is provided that the display device is configured as a mobile end device, in particular smartphone, of the passenger, as a screen of an infotainment system which is assigned to the respective aircraft seat and/or as a screen of a cabin control system. The seating system may also comprise a plurality of display devices. For example, a central display device and one assigned display device per passenger or seat may be provided. The use of a smartphone as a display device makes it possible to dispense with additional permanently installed display devices, which entails that the system can be particularly cost-effective and light. A smartphone is now carried by almost every traveler. Moreover, the passenger can thus prevent his/her sitting data from being viewed by others and/or analyze for himself/herself his/her sitting behavior even after the flight has ended, for example at home. An assigned screen, for example in an armrest of the seat and/or in a backrest of another aircraft seat located in front of the passenger in the sitting direction, a screen on the ceiling of the cabin and/or a wall screen located in front of the passenger in the sitting direction may also be used as a display device. These screens are usually used to play back films from the infotainment system, so that likewise no additional display device for the seating system in the aircraft must be installed.

In a further advantageous embodiment of the seating system according to the first aspect of the invention, it is provided that the evaluation device is configured as a mobile end device, in particular smartphone, of the passenger, as a computing unit of an infotainment system which is assigned to the respective seat and/or as a computing unit of a cabin control system. In this way, it is again possible to dispense with additional devices to be installed in the aircraft cabin. In particular, the smartphone may be configured as a display device and an evaluation device. By using the smartphone as an evaluation device, in particular the level of data protection for the passenger can be high, since the evaluation can only be carried out by a device that is personally accessible to the passenger.

In a further advantageous embodiment of the seating system according to the first aspect of the invention, it is provided that the evaluation device is configured to determine a sitting posture depending on the detected seat load. Preferably, the evaluation device is further configured to determine the recommendation for a change in the sitting posture depending on the determined sitting posture and/or the at least one display device is configured to graphically display the sitting posture determined by the evaluation device. In this way, recommendations for the change in the sitting posture can be generated which are particularly comfortable for the passenger. In addition, an evaluation of respective stored data is thus facilitated in order to improve the seating system and/or its recommendations. The comprehensibility of the recommendations is thus also increased for the passenger. In particular, it is thus possible for the passenger to recognize which sitting postures are disadvantageous for him/her and to generally avoid them.

In a further advantageous embodiment of the seating system according to the first aspect of the invention, it is provided that the sensor device is configured to detect a temporal history/chronological sequence of the detected seat load. Preferably, furthermore the evaluation device is configured to determine a recommendation for a change in the sitting posture depending on the detected history of the seat load and/or the display device is configured to display the temporal history of the detected seat load. By means of a detection of the temporal history, in addition to the current seat load and/or sitting posture, previous seat loads and/or sitting postures as well as a dwell time in respective sitting postures and/or a duration of a seat load can be used to determine the recommendation. Thus, respective recommendations can be particularly well matched to the sitting behavior of the passenger and a particularly high level of comfort can be achieved. The detection of the temporal history makes it possible to determine recommendations for avoiding remaining in a sitting posture for too long when the sitting posture in itself is advantageous. This is because remaining too long in the sitting posture that in itself is advantageous can also be uncomfortable and/or stressful to health in the long term. Additionally, a temporal history of seat occupancy can thus be detected and stored, and, should the situation arise, these data can be used to repel claims for damages from passengers who are not seated in the event of turbulence. Respective seat loads can be detected and/or stored together with a time stamp. A detection of a temporal history also enables a subsequent evaluation by the evaluation device and then, for example, the output of recommendations for the sitting behavior for the next flight. Preferably, the seating system alternatively or additionally operates live, that is, recommendations are determined and displayed during the flight, where appropriate continuously or quasi-continuously with intermittent recommendation displays as soon as a sitting posture is to be changed. The detected temporal history may also be used for further developing the recommendation program and/or for analyzing in more detail passenger behavior in the aircraft cabin.

The evaluation device preferably may also be configured to detect whether the seated person is asleep depending on the temporal history of the seat load and/or the sitting posture. If it is detected that the seated person is asleep, for example, the output of recommendations may be deactivated so as not to disturb the sleeper. Alternatively, the display device may be switched to a sleep mode, in which recommendations are displayed differently. For example, a recommendation can then be displayed without an accompanying vibration signal and/or with reduced illumination.

Preferably, the temporal history may also be used to calculate a kind of point system for the passenger's sitting behavior and/or seat load behavior, by means of which an aggregated evaluation of the passenger's sitting behavior can be detected. It can also be taken into account, for example, whether the passenger takes into account or follows recommendations and how comfortable and/or health-friendly his/her behavior is. This enhances the passenger's understanding and comprehensibility of his/her behavior. It is also possible to set targets by which the passenger can be guided. Advantageous seat load or sitting behavior can also be rewarded, for example by bonus miles from the airline, in order to create further incentives for a comfortable travel and increase passenger loyalty to the airline.

In a further advantageous embodiment of the seating system according to the first aspect of the invention, it is provided that the evaluation device is configured to determine a temporal history of the passenger's sitting posture depending on the detected history of the seat load. Preferably, the evaluation device is configured to determine a recommendation for a change in the sitting posture depending on the detected history of the sitting posture and/or the display device is configured to display the temporal history of the determined sitting posture. As regards respective advantages and possible further configurations and features, the above statements in connection with the detection of the temporal history of the sitting posture apply analogously. The detection of the temporal history of the sitting posture additionally or alternatively to the seat load enables a particularly precise, fast and simple analysis and/or evaluation. In addition, respective data are then easy to understand even for the layperson.

In a further advantageous embodiment of the seating system according to the first aspect of the invention, it is provided that the seating system comprises a storage device which is configured to store the detected seat load, the determined sitting posture, the history of the detected seat load, the history of the determined sitting posture and/or respective recommendations for a change in the sitting posture. Preferably, the display device is configured to display the stored seat load, the stored sitting posture, the stored history of the detected seat load, the stored history of the determined sitting posture, and/or respective recommendations for a change in the sitting posture. The storage device may be configured, for example, as a memory of the infotainment system and/or the cabin control system. However, the storage device may also be configured, for example, as a mobile end device, in particular as a memory of a smartphone or as a central server. The storage device may also be configured to store the respective data on a plurality of memories, for example the assigned data of the respective passengers on their smartphones as well as the data of all passengers centrally on the server. Thus, the smartphone may be configured as a display device, an evaluation device as well as a storage device, which results in that the seating system comprises particularly few components and is particularly cost-effective. Respective data can be stored per flight and/or passenger. Centrally stored data to which not only the respective passenger has access can be anonymized, for example by the evaluation device, before storage and/or transmission to the storage device. The storage of the data enables extensive subsequent analyses, in particular studies on the sitting behavior of passengers in aircraft, can serve to further develop safety concepts and can be useful in the further development of aircraft seats and seat recommendations.

In a further advantageous embodiment of the seating system according to the first aspect of the invention, it is provided that a respective recommendation for the change in the sitting posture comprises a change to another sitting posture, a change to a new sitting posture, in particular to a predetermined sitting posture and/or to a new sitting posture ascertained depending on the previous sitting posture of the passenger, leaving the aircraft seat and/or a sequence of movements. For example, a recommendation to maintain the sitting posture and/or seat load may also be displayed if the determination of the recommendation results in that no change in the sitting posture and/or seat load is advantageous and/or necessary at this time. The recommendation may also optionally comprise a temporal component. For example, it may be determined as a recommendation that in a specific time, such as 15 min, the sitting posture should be changed and/or how long the passenger should remain in this sitting posture, in particular maximally, for example no longer than 45 min. Especially long sitting in a, in particular unhealthy, sitting posture can thus be avoided. As a recommendation, leaving the seat may also be determined and displayed as a change in the sitting posture. For example, the passenger may be requested to move through the aircraft aisle. Thus, e.g., thromboses can be avoided particularly well. Respective display devices and/or evaluation devices may comprise a communication interface in order to coordinate with each other. It can thus be avoided that too many passengers are requested to leave their seats at the same time. This coordination may be performed, for example, centrally by a server and/or a cabin control system or central infotainment system. The recommendation may also comprise a time period of leaving the seat and specific movement, stretching and/or gymnastic exercises. The respective recommendations may comprise, for example, symbols, pictograms, animations and/or text, which is/are displayed.

In a further advantageous embodiment of the seating system according to the first aspect of the invention, it is provided that the sensor device is configured to detect at least one force at two different points as the seat load. For example, respective seat surfaces of the seat part, respective back surfaces of the back part and/or respective support surfaces of the armrests of the seat may be divided into sectors or form a respective sector in which the respective seat load is detected separately. A center of gravity of the seat load can also be easily determined thereby. Thus, a particularly precise determination of the passenger's sitting posture is possible. For example, a seat load distribution of the seat surface and/or the back surface may be detected and/or determined, for example separately for left, right, front and rear. A corresponding sensor arrangement may be provided for this purpose, comprising, for example, one assigned sensor each at the front, rear, left and right under the seat surface and/or under the back surface. This means that the sensor device may be configured to detect different areas of the seat separately and/or to detect respective surface loads, in particular pressure loads. The seating system can accordingly detect and/or determine where one or more seat centers of gravity are, for example on a seat trampoline or seat cushion of the aircraft seat, on the backrest of the aircraft seat and/or on respective armrests of the aircraft seat. Hence, the sensor device as a whole may be configured to detect the intensity, location and/or distribution of a seat load. The sensor device thus may also be configured to detect the seat load resolved according to different seat areas. A seat area may correspond to the seat part, the backrest and/or the respective armrests, or to subareas thereof. For example, the seat part may also be divided into a plurality of, for example four, seat areas, the seat loads of which are separately detected.

In a further advantageous embodiment of the seating system according to the first aspect of the invention, it is provided that the sensor device comprises at least one sensor. The sensor may preferably be configured as a pressure sensor. Preferably, the sensor detects a force acting thereon by a change in an electrical resistance and/or a capacitance. The sensor may preferably be configured as a mechanical and/or inductive proximity sensor. For example, a reed switch or Hall sensor may be used as the sensor. The sensor may be configured as a surface sensor, in particular as a textile surface sensor, capacitive surface sensor and/or capacitive textile surface sensor. A surface sensor can advantageously detect a surface load. The textile sensor, for example, may be formed by two capacitive wires which are fixed to each other in a manner spaced apart from each other by a 3D textile in or on which they are connected. Pressure on the textile reduces the space between them, resulting in a detectable change in capacitance. The surface sensor may also be formed by using a conductive yarn as the electrode and a foam as the dielectric. The surface sensor may be structured in the form of a matrix in order to enable a spatial resolution of the detection. The sensor device may comprise an analysis device which evaluates respective sensor signals. It is also possible to mix different types of sensors in the case of a plurality of provided sensors in order to be able to use their respective advantages in a selective manner depending on the position and/or to improve the measuring accuracy.

A capacitive surface sensor enables a particularly precise seat load or pressure determination. For example, even in the case of loads of more than 5 kg, their location can precisely be determined. A capacitive sensor can detect minimal changes, shifts in weight and/or pressure loads. The capacitive sensor may use the principle of a touch display. A capacitive textile surface sensor may comprise two fabrics, in particular each forming or comprising an electrode, between which an insulator, in particular an insulator layer and/or formed as a dielectric, is arranged. Especially in the case of aircraft seats, the seat surface is much smaller than, for example, in motor vehicle seats. Thus, a seat surface in aircraft seats is generally occupied for the most part, irrespective of the sitting posture. Accordingly, in order to assess the sitting posture, it is not only necessary to ascertain whether parts of the seat surface are loaded or not. Rather, it is also important to ascertain which surface is occupied with what pressure. It is thus possible in the case of aircraft seats to output a particularly useful recommendation for a change in the sitting posture or a shift in weight on the basis of the seat load or sitting posture. Thus, capacitive sensors, in particular capacitive surface sensors, are particularly suitable. Capacitive textile surface sensors can be integrated into aircraft seats in a particularly simple and weight-saving manner. Furthermore, a capacitive surface sensor has a particularly low power consumption. In contrast to, for example, a resistance sensor, a capacitive sensor can only consume power when measurements are made due to changes in weight and/or pressure. Moreover, a capacitive sensor generates little or no heat at all during operation, which entails that it can be particularly safe.

In a further advantageous embodiment of the seating system according to the first aspect of the invention, it is provided that the sensor device comprises at least one sensor which is arranged in a back part, a seat part and/or an armrest of the seat. The back part may also be referred to as backrest and optionally comprise a headrest. In this way, the seat load can be detected particularly well. Preferably, respective sensors are arranged in a recess of a foam layer of the seat and/or as a sensor layer between the foam layer and a cover layer of the seat. However, a respective sensor may also form the cover layer of the seat itself, in particular the seat part, the back part and/or respective armrests, in particular if the sensor is configured as a textile sensor. Additionally, a textile sensor is particularly suitable as a sensor layer between the foam layer and the cover layer of the seat. Surface sensors may extend along the entire seat surface, back surface and/or respective support surfaces or only in partial areas. Preferably, at least one sensor each is provided per seat part, per back part and optionally per armrest, particularly preferably at least two sensors per seat part and per back part. The seat part may comprise a seat cushion and/or a seat trampoline. The foam layer may also be referred to as the seat foam or foam of the seat. Preferably, the foam layer serves as the seat padding. A surface sensor, in particular a textile sensor, may also form the seat trampoline itself. The seating system itself is thereby particularly light and respective seat loads can be detected particularly precisely.

In a further advantageous embodiment of the seating system according to the first aspect of the invention, it is provided that the sensor device comprises at least one power supply device. In particular, the power supply device may comprise a battery, such as a button cell, or a rechargeable battery, such as a lithium-ion battery. Alternatively or additionally, the sensor device may be configured to be connected to an on-board power supply of the passenger aircraft, in particular to a power supply of an infotainment system. By additionally providing such a connection, the power supply is redundant, in other respects an energy storage can be omitted, which entails that the seating system can be particularly light. By the connection to the infotainment system, the power supply can be provided with particularly little effort. Similarly, the evaluation device and/or the display device may also be configured to be connectable to the on-board power supply and/or comprise a power supply device. Preferably, respective seating system components integrated in the seat share a power supply device or have a common connection to the on-board power supply.

Alternatively, the sensor device is configured to be able to detect the seat load without a power supply. For example, sensors configured as piezo sensors can generate a sensor signal without a power supply. The seating system can then be particularly light and low-maintenance.

In a further advantageous embodiment of the seating system according to the first aspect of the invention, it is provided that the seating system comprises a system for detecting and displaying a fastening state of at least one aircraft seat belt or is configured to be connected to such a system. Thus, safety can be increased and/or checking whether all passengers are wearing seat belts can be simplified. For example, it can thus be determined afterwards whether a seated passenger was actually wearing a seat belt at a specific time. Furthermore, it does not have to be checked whether a passenger is actually sitting on the corresponding aircraft seat when the seat belt is displayed as unfastened. In this regard, a further synergy effect can arise from the fact that the seating system and the system for detecting and displaying a fastening state of at least one aircraft seat belt can share a display device and/or an evaluation device. The functionality of both systems can thus be provided together at low cost and weight. Data exchange between the two systems can be performed by means of suitable interfaces, for example wirelessly or by wire, or in that evaluation devices and/or display devices can be shared by both systems. A suitable exemplary system for detecting and displaying a fastening state of at least one aircraft seat belt is described in application DE 10 2018 002 819.5.

In a further advantageous embodiment of the seating system according to the first aspect of the invention, it is provided that the seating system comprises a data processing module, in particular configured as an A/D converter, by means of which sensor data of the sensor device are converted for processing by the evaluation device and/or for display by the display device, in particular from an analog sensor signal into a digital sensor signal. The data processing module may be arranged in a foam layer of the seat or, for example, in or on a backrest. The data processing module may use the power supply device of the sensor device and/or may also be formed as part of the sensor device. The data processing module may also comprise a separate power supply device, such as a button cell, or be configured to be connected to the on-board power supply of the aircraft.

In a further advantageous embodiment of the seating system according to the first aspect of the invention, it is provided that the seating system is configured for wired data transmission between the sensor device, the display device, the evaluation device and/or the storage device, in particular for connection to data transmission via a data transmission network of the infotainment system. Alternatively or additionally, the seating system may be configured for wireless data transmission between the sensor device, the display device, the evaluation device and/or the storage device, in particular by means of the Bluetooth standard, the Bluetooth low energy standard, WLAN, in particular in specific frequency bands, and/or by means of RFID. Data transmission by means of the Bluetooth low energy standard has particularly low energy consumption and can thus be particularly low-maintenance. Data transmission by means of WLAN has a particularly long range, can use an existing on-board WLAN and is particularly suitable for data transmission for central storage, display and/or evaluation. The range of the data transmission can be increased by respective repeaters in the aircraft cabin and/or a limited range can be compensated for by respective gateways, for example with fixed wiring or likewise further wireless data transmission, in the aircraft cabin. Thus, transmission over long distances, for example to the cabin control system, is readily possible and/or transmission of a plurality of aircraft seats and their corresponding assigned sensor devices may be bundled. The seating system and/or its individual components may comprise corresponding transmitters, such as Bluetooth low energy transmitters, WLAN transmitters, and/or corresponding RFID chips and readers. Data transmission may be continuous, quasi-continuous or intermittent, for example in the case of an RFID chip, only when the passenger exits the aircraft and passes through an RFID reader of the seating system, for example integrated in a gateway of the airport. The RFID data transmission thus requires particularly few components in the aircraft itself.

Preferably, the materials used, such as fabrics, are equipped to be flame retardant. Preferably, the data transmission is configured such that it does not or cannot cause interference with the on-board WLAN or other data transmissions of the aircraft. The configuration of the power supply and data evaluation is preferably such that there is only one interface and/or wire entry to the sensor device, in particular to a surface sensor configured as a mat, in order to increase safety by reducing the probability of a short circuit and reducing the manipulability by passengers. Approval in the aviation sector is simplified thereby.

A second aspect of the invention relates to a method for operating a seating system for a passenger aircraft, comprising at least the steps of detecting a seat load of an aircraft seat by a passenger sitting thereon by means of a sensor device, determining a recommendation for a change in a sitting posture of the passenger depending on the detected seat load, and displaying the recommendation on a display device. The method enables an increase in travel comfort for respective passengers of a passenger aircraft, since the passengers can be guided towards a better sitting behavior.

The method according to the second aspect of the invention is suitable for operating the seating system according to the first aspect of the invention. The features and advantages resulting from the seating system according to the first aspect of the invention can be deduced from the description of the first aspect of the invention, wherein advantageous embodiments of the first aspect of the invention are to be regarded as advantageous embodiments of the second aspect of the invention and vice versa.

In a further advantageous embodiment of the method according to the second aspect of the invention, a sitting posture of the passenger can be determined depending on the seat load, a temporal history of the seat load can be detected and/or a temporal history of the sitting posture of the passenger can be determined and the recommendation for the change in the sitting posture can be determined depending on the determined sitting posture, the history of the seat load and/or the history of the sitting posture. Thus, travel comfort and safety for the passenger can be further increased and additionally further analyses of the sitting behavior of the passengers are thus easily possible.

In a further advantageous embodiment of the method according to the second aspect of the invention, a respective recommendation for the change in the sitting posture may comprise a change to another sitting posture, a change to a new sitting posture, in particular to a predetermined sitting posture and/or to a new sitting posture ascertained depending on the previous sitting posture of the passenger, leaving the seat and/or a sequence of movements. By means of these respective types of recommendations, the passenger can be instructed for a particularly advantageous sitting behavior in terms of comfort and health.

Preferably, in the case of the method according to the second aspect of the invention also a weight of the respective passenger is determined depending on the seat load, which entails that a more economical operation of the passenger aircraft can be made possible.

A third aspect of the invention relates to a computer-implementable program product. The program product is configured to determine a recommendation for a change in the sitting posture based on a seat load of an aircraft seat by a passenger detected by a sensor device, and to convert the recommendation for display on a display device. Thus, travel comfort for a passenger of the passenger aircraft can be improved by using the program and following the recommendations. The program product is suitable to be used with the seating system according to the first aspect of the invention and/or to implement the method according to the second aspect of the invention. The features and advantages resulting from the seating system according to the first aspect of the invention and from the method according to the second aspect of the invention can be deduced from the description of the first and second aspects of the invention, wherein advantageous embodiments of the first and second aspects of the invention are to be regarded as advantageous embodiments of the third aspect of the invention and vice versa.

For example, the program product may be configured to be stored on a mass storage, such as a hard disk, floppy disk, DVD, CD, ROM memory and/or RAM memory. The program product or parts thereof may be executed by, for example, a computer, a smartphone, or a part of an infotainment system or cabin control system of a passenger aircraft. The program product may also be referred to as software.

Preferably, in the case of the program product, respective recommendations for the change in the sitting posture comprise a change to another sitting posture, a change to a new sitting posture, in particular to a predetermined sitting posture and/or to a new sitting posture ascertained depending on the previous sitting posture of the passenger, leaving the seat and/or a sequence of movements. Thus, travel comfort and safety for the passenger can be further increased and additionally further analyses of the sitting behavior of the passengers are thus easily possible.

Preferably, the program product converts the recommendation(s) into a graphical and/or animated representation for display on the display device. Thus, the representations can be directly output by respective display devices.

Preferably, the program product is configured as an application for a smartphone, in particular as a component of a passenger application of an airline for smartphones. The passenger application may, for example, also allow booking, check-in and/or management of seats by a customer of the airline, who may also be the passenger. Thus, an interface for interaction of the customer with the airline can be expanded via his/her smartphone. In particular, the program product may thus be provided to the customer in the form of an update, so that an additional installation of separate software is not necessary. The customer may thus automatically be provided with the comfort enhancement through sitting posture recommendations. This may increase customer loyalty. In addition, the passenger application may comprise or enable registration of the customer so that respective collected data can be assigned to specific persons.

A fourth aspect of the invention relates to a sleeping system for a passenger aircraft, in particular the crew thereof, which comprises at least one reclining element, in particular a mattress or a bed, comprising at least one sensor device configured to detect an occupancy of the reclining element by a person located thereon. Furthermore, the sleeping system may comprise a display device configured to display the occupancy of the reclining element. It can be indicated thereby whether a resting or sleeping space is available. In particular, a crew member can thus check whether a bed is available for him/her without having to go to the bed itself and thereby possibly disturbing a person sleeping in it. The display device may, for example, be configured as a cabin control system or as a display in a cockpit of the passenger aircraft.

The sleeping system according to the fourth aspect of the invention may comprise all features according to the first aspect of the invention. Preferably, in this case, too, the sensor device of the sleeping system is configured to detect a posture of the person on the reclining element. The posture may be, for example, a lying posture, sleeping posture and/or resting posture. For this purpose, the sleeping system according to the fourth aspect of the invention may also comprise an evaluation device for determining a recommendation for a posture depending on the detected posture on the reclining element. The display device may be configured to display the recommendation. The person lying on the reclining element can thereby adopt a particularly restful posture.

Furthermore, preferably respective detected occupancies and/or postures can also be stored in a storage device of the sleeping system according to the fourth aspect of the invention. Thus, respective rest periods of crew members can be detected and their compliance can be checked. Thus, safety can be increased and unacceptably long rest periods can be avoided, which entails that the crew is better available for the passengers and accordingly the travel comfort for the passengers can be higher. Simultaneous resting of an unacceptably large number of crew members can also be avoided in this way.

In addition, the sensor device may also be configured to detect impermissible double occupancy of a reclining element. This can also be displayed by the display device and/or stored by the storage device. This can also increase safety. In addition, inappropriate behavior of crew members on the reclining element can thus be detected for disciplinary measures and/or avoided from the outset to prevent damage to the reputation of the airline due to the existing monitoring.

The sleeping system may also be configured for reclining elements, such as, for example, beds, for passengers. In particular, the sleeping system may also be realized by a seating system according to the first aspect of the invention, if the corresponding aircraft seat is adjustable from a seating configuration to a reclining configuration. Then the seat can also be used as a reclining element or bed. Additional components are not absolutely necessary in this case. In this way, too, the travel comfort for passengers can be increased and data can be collected for analyzing the sleeping behavior of respective passengers in addition to a sitting behavior.

Hence, the sleeping system can be realized by the seating system according to the first aspect of the invention and/or operated by the method according to the second aspect of the invention, which can also be implemented in a program product according to the third aspect of the invention. The features and advantages resulting from the seating system according to the first aspect of the invention and from the method according to the second aspect of the invention as well as from the program product according to the third aspect of the invention can be deduced from the description of the first, the second and the third aspect of the invention, wherein advantageous embodiments of the first, the second and the third aspect of the invention are to be regarded as advantageous embodiments of the fourth aspect of the invention and vice versa.

A fifth aspect of the invention relates to a seating system for a passenger aircraft, comprising at least one aircraft seat comprising at least one sensor device. The sensor device may be configured to detect a seat load on the aircraft seat by a passenger sitting thereon. The sensor device may correspond to the sensor device of previous aspects. Furthermore, the seating system may comprise a storage device configured to store the detected seat load, a determined sitting posture, a history of the detected seat load, and/or a history of the determined sitting posture. The sitting posture may be determined as in the previous aspects, in particular by means of an evaluation device. Furthermore, the seating system may comprise an evaluation device which is configured to ascertain how good the passenger feels on the aircraft seat depending on the detected seat load, the determined sitting posture, the history of the detected seat load and/or the history of the determined sitting posture. Thus an evaluation of customer data by airlines and/or interior outfitters and/or aircraft seat manufacturers is made possible in order to increase travel comfort for passengers.

For example, it can thus be ascertained in which areas of the aircraft the comfort for passengers is higher. For example, some passengers may be sitting more comfortably further back in the aircraft and other passengers may be sitting more comfortably further forward in the aircraft. A live evaluation during the flight is also possible. For example, if a level for the sense of well-being of a passenger falls below a certain threshold value, the passenger may be offered products, food, drinks and/or a different seat during the flight. All in all, customers can thus be addressed in a selective, effective and personalized manner.

How good a passenger feels may be calculated, for example, as an abstract level, for example on a scale of 1 to 10. To this end, for example, experimental data may be used with which respective detected data are compared. For example, the behavior and/or seat load of seated test persons or test passengers may be detected and their sense of well-being determined by means of a questionnaire. These data can then be stored in a database and used for the evaluation.

The evaluation device and/or the storage device may correspond to the evaluation device and/or storage device of previous aspects. In particular, the evaluation device may be an evaluation device which is also configured to determine a recommendation for a change in a sitting posture depending on the detected seat load. The seating system according to the fifth aspect may also comprise a display device configured to display the recommendation for the change in the sitting posture. The seating system according to the fifth aspect may also be a part of the seating system according to the first aspect of the invention and vice versa and/or operated by the method according to the second aspect of the invention, which may also be implemented in a program product according to the third aspect of the invention. The features and advantages resulting from the seating system according to the first aspect of the invention, from the method according to the second aspect of the invention, from the program product according to the third aspect of the invention and from the sleeping system according to the fourth aspect of the invention can be deduced from the description of the first, the second, the third and the fourth aspect of the invention, wherein advantageous embodiments of the first, the second, the third and the fourth aspect of the invention are to be regarded as advantageous embodiments of the fifth aspect of the invention and vice versa.

In a further advantageous embodiment of the fifth aspect, it is provided that the sense of well-being of the passenger on the aircraft seat is determined depending on how often the passenger moves, how intensely the passenger moves, in which way the passenger moves, how often and/or how long the passenger sleeps and/or how often the passenger stands up. For example, moving frequently back and forth may indicate an uncomfortable seat and/or that the passenger does not feel good, as may standing up frequently. Sleeping long and/or frequently, on the other hand, may indicate an intense sense of well-being and/or high travel comfort. Sleeping can be recognized, for example, by means of only very slight changes in the sitting posture. Likewise, sleeping can also be ascertained, for example, by comparing the detection of the seat load of test passengers or seated test persons who are sleeping. The determination whether a person is sleeping may be performed by means of the evaluation device.

In a further advantageous embodiment of the fifth aspect, it is provided that the storage device is configured to store the detected seat load, the determined sitting posture, the history of the detected seat load and/or the history of the determined sitting posture in a manner assigned to a passenger and/or a respective aircraft seat type. The individual passenger may be identified, for example, by the identifier of his/her bonus miles program. By means of the assignment, the travel comfort for this individual passenger or customer can be optimized. By the assignment to a seat type, the airline or manufacturer can evaluate which seats are particularly comfortable. The seat type may be a specific model or design, for example. The aircraft seat type may also correspond to and/or take into account a location on the aircraft. Likewise, the distance to other seats may also be part of the aircraft seat type and/or detected in a manner assigned to the stored data. By means of a corresponding data evaluation, aircraft seats may be improved and/or the data may serve as a basis for the further development of aircraft seats. All in all, the travel comfort can be increased in this way, too.

A sixth aspect of the invention relates to a method for operating a seating system for a passenger aircraft, comprising at least the steps of detecting a seat load of an aircraft seat by a passenger sitting thereon by means of a sensor device, storing the detected seat load, a determined sitting posture, a history of the detected seat load and/or a history of the determined sitting posture, in particular in a manner assigned to an individual passenger and/or a respective aircraft seat type, and ascertaining how good the passenger feels on the aircraft seat depending on the detected seat load, the determined sitting posture, the history of the detected seat load and/or the history of the determined sitting posture, wherein the sense of well-being of the passenger on the aircraft seat is preferably determined depending on how often the passenger moves, how intensely the passenger moves, in which way the passenger moves, how often and/or how long the passenger sleeps and/or how often the passenger stands up.

Thus, the method according to the sixth aspect is particularly suitable for operating the seating system according to the fifth aspect. The features and advantages resulting from the seating system according to the fifth aspect of the invention can be deduced from the description of the fifth aspect of the invention, wherein advantageous embodiments of the fifth aspect of the invention as well as also of the first, the second, the third and the fourth aspect of the invention are to be regarded as advantageous embodiments of the sixth aspect of the invention and vice versa.

Further advantages, features and details of the invention are apparent from the following description of a preferred embodiment and from the drawings. The above features and combinations of features mentioned in the description, as well as the features and combinations of features mentioned below in the description of the Figures and/or shown only in the Figures can be used not only in the respectively indicated combination, but also in other combinations or on their own, without departing from the scope of the invention.

### BRIEF DESCRIPTION OF THE DRAWINGS

FIG. 1 is a schematic view illustrating a seating system for a passenger aircraft.

FIG. 2 is a schematic flow diagram illustrating the mode of operation of the seating system according to FIG. 1.

FIG. 3 is a schematic perspective view depicting an aircraft seat.

FIG. 4 is a schematic sectional view depicting a cushion of the aircraft seat according to FIG. 3.

### DETAILED DESCRIPTION

FIG. 1 is a schematic view illustrating a seating system 10 for a passenger aircraft, comprising a passenger seat 12. The aircraft seat 12 may also be referred to as seat 12 and comprises a back part 14, which may also be referred to as backrest, a seat part 16 and respective armrests 18. The back part 14 integrally comprises a headrest, which may also be regarded here as part of the backrest. The aircraft seat 12 is detachably attached to a floor of the passenger cabin of the passenger aircraft by means of a frame 20.

A passenger 22 is seated on the aircraft seat 12 in a specific sitting posture. Presently, for example, the passenger 22 is shown leaning against the backrest with at least the elbow of one of his arms resting on the depicted armrest 18. The head of the passenger 22 is also leaning against the backrest 14. In addition, the passenger 22 sits on the seat part 16, with a seat center of gravity given far back toward the back part 14. However, the passenger 22 could also sit differently on the aircraft seat 12. For example, the passenger 22 could be leaning forward so that his/her back and head are no longer in contact with the back part 14 and a seat center of gravity is shifted on the seat part 16 near an end away from the back part 14.

The seating system 10 comprises a sensor device 24, which is configured to detect a seat load of the aircraft seat 12 by the passenger 22 sitting thereon. The respective seat load results from a respective sitting posture and corresponds, for example, to a pressure load of a back surface of the back part 14, a seat surface of the seat part 16 and a support surface of respective armrests 18, resolved according to areas. Thus, in the present case, it can be detected, for example, by means of the sensor device 24 where the seat center of gravity is on the seat part 16 and which force acts on the seat part 16. The same can be detected for the back part 14 and respective armrests 18

For the purpose of this detection, the sensor device 26 comprises, for example, a plurality of sensors 26 spaced apart from each other. The sensors 26 may be configured, for example, as surface textile sensors, which can detect the force acting thereon by a change in capacitance or resistance. Such textile sensors may be configured also themselves to detect a force distribution acting thereon in order to be able to determine the seat load particularly accurately. Optionally, one sensor 26 may then be provided per seat part 16, back part 14 and armrest 18, for example, and extend over essentially the entire seat surface, back surface and support surface. In this way, the seat load can be detected with particularly high resolution and accuracy. By providing—as shown herein—a plurality of spaced-apart sensors 26 per seat surface, back surface and support surface, the sensor device 24 can be particularly light. Respective values or loads between the sensors 26 may, for example, be averaged.

For example, the sensors 26 may be powered by an energy storage, such as a battery, which is arranged in or on the aircraft seat 12. Alternatively or additionally, the respective sensors 26 may also be connected to an on-board power supply, for example a power supply of parts of an infotainment system of the passenger aircraft, and supplied with power therefrom. Alternatively, respective sensors 26 may be used that do not require power to generate a sensor signal. For example, piezoelectric sensors may be used, which can generate an electrical voltage without a power source when subjected to pressure. Such a sensor device 24 may be particularly low maintenance.

The sensors 26 are connected by respective lines to a central transmitting device 28, which comprises, for example, a transmitter 30 that is configured to send sensor signals using the Bluetooth low-energy standard. The transmitting device 28 can convert respective analog sensor signals into digital signals by means of an integrated A/D converter.

By means of the transmitting device 28, respective sensor signals and thus the detected seat load can be transmitted to an evaluation device 32, which in the present case is configured as a smartphone 34 of the passenger 22. The smartphone 34 also comprises a display device 36 in the form of a screen, a receiver 38 for receiving the sensor signals transmitted by the transmitting device 28, and a mass storage not shown.

The smartphone 34 or the evaluation device 32 is configured to determine a recommendation for a change in the sitting posture of the passenger 22 depending on the detected seat load. For this purpose, the smartphone 34 can execute, for example, a program, which may also be referred to as app, by means of which the sensor signals are evaluated with a tabular comparison in order to determine whether a change in the sitting posture is advantageous for the passenger 22 in terms of comfort or health effects. It may also be determined to which sitting posture the passenger 22 should advantageously change.

The recommendation thus determined may be displayed on the display device 36 by means of the smartphone 34, for example in the form of a pictogram or animation. Thus, the passenger 22 can be guided as to how, when and which sitting postures he/she should adopt during a flight in order to increase the seating comfort and minimize a health burden caused by long periods of sitting. In this way, the passenger 22 can also be helped to improve his/her sitting behavior.

By means of the detected seat load, the evaluation device 32 can also determine a current sitting posture and display it to the passenger 22 on the display device 36. This can facilitate the understanding of the sitting behavior and, if necessary, better clarify to the passenger 22 how his/her sitting behavior should be during flight.

The seating system 10 can also detect a temporal history of the seat load and/or sitting posture and store it, for example, in the mass memory of the smartphone 34. Thus, temporal factors, such as, for example, the period of time the passenger 22 remains in a sitting posture, can also be taken into account when determining the recommendation. By the storing operation, respective detected data can also be used for later, more comprehensive analyses and/or analyses accumulated for a plurality of passengers.

The aircraft seat 12 may also comprise a mechanism for adjusting individual parts. For example, the back part 14 may be held to the frame 20 by means of a joint 40 in order that an inclination of the backrest can be adjusted. Likewise, respective armrests 18 may be held to the back part 14 by means of a further joint 42 in each case. Respective wires for transmitting respective sensor data of the sensors 26 may be guided through these joints 40, 42, as shown for example at joint 42.

The sensor device 24 may be configured to detect the position of respective movable or adjustable parts of the aircraft seat 12. For example, the sensor device 24 may comprise a position sensor by means of which the positions of the respective joints 40, 42 are detected. The detected position of respective movable or adjustable parts of the aircraft seat 12 may also be taken into account by the evaluation device 32 when detecting the seat load and/or determining the current sitting posture. Thus, the accuracy can be improved in this regard. Moreover, the recommendation for a change in the sitting posture may also be determined by the evaluation device 32 depending on the detected position of respective movable or adjustable parts of the aircraft seat 12. The recommendation may then also comprise a recommendation for adjusting respective movable or adjustable parts of the aircraft seat 12 or, for example, only recommend adopting such sitting postures that do not require an adjustment of these parts.

The smartphone 34 may optionally also be configured to send respective detected data and/or recommendations to a central server for storing them there as well. This stored information is then available to the airline for further use and/or can be viewed centrally, for example by respective flight attendants in a cabin control system. In this way, a seat occupancy can also be detected. Furthermore, the seating system 10 may also comprise a plurality of aircraft seats 12 with respective assigned sensor devices 24, wherein respective data and/or respective recommendations of an individual passenger may be made available only to that passenger on his/her smartphone.

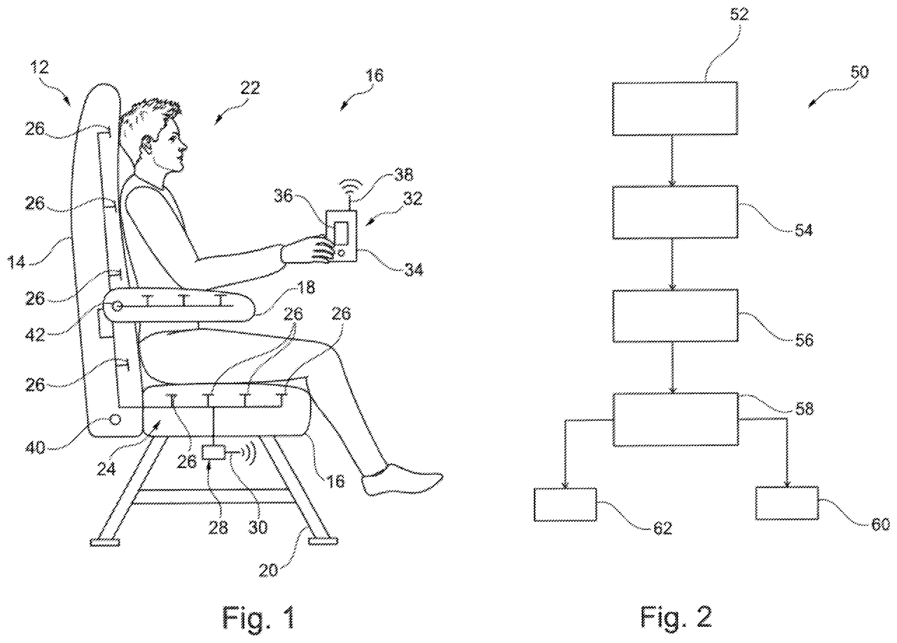

FIG. 2 illustrates in a schematic flow diagram 50 the mode of operation of the seating system 10 according to FIG. 1. Block 52 illustrates the transmission of detected sensor data—i.e., signals which allow conclusions to be drawn about the seat load or detect the seat load—as electrical signals from the sensors to the A/D converter of the data transmission module or the transmitting device 28. In block 54 the conversion of these analog electrical signals into digital signals is illustrated and in block 56 their transmission to the evaluation device 32 is illustrated, wherein the transmission is preferably wireless. The evaluation of the transmitted data is illustrated in block 58, wherein in this step a recommendation for a change in the sitting posture of the passenger 22 is determined by means of the evaluation device 32 on the basis of the detected seat load and optionally additionally its temporal history, which is also referred to as seat history. This recommendation may also comprise a type of prognosis, for example that, after further remaining in a current sitting posture for a predetermined period of time, the passenger 22 is recommended to change to another, in particular predetermined, position.

Block 60 then illustrates that the recommendation is output to the passenger 22, for example in the form of an animation on the screen of his/her smartphone 34. Block 62 illustrates that respective output recommendations and/or detected seat loads and/or sitting postures, in particular their temporal history, are stored, for example on a central server and/or on the smartphone 34 of the respective passenger.

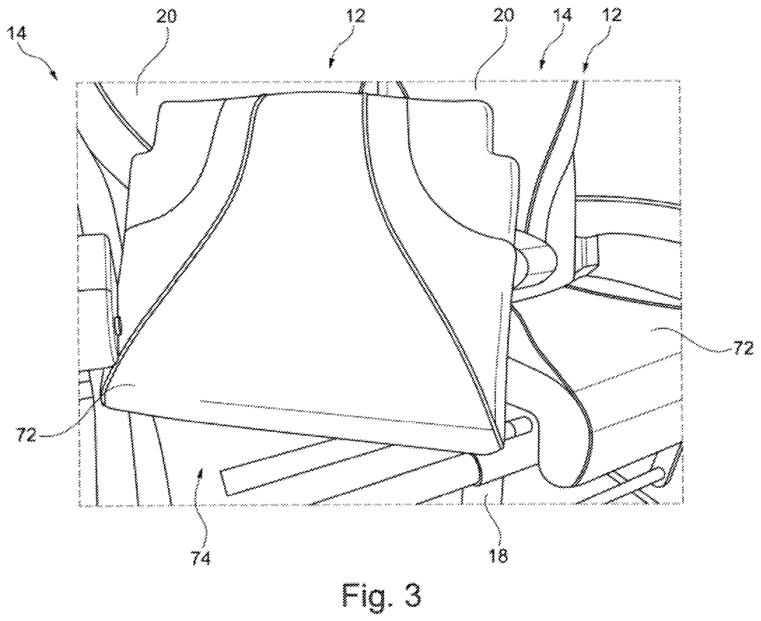

FIG. 3 is a schematic perspective view depicting two of the aircraft seats 12, one of which is schematically shown in FIG. 1, as a row of seats. It is readily apparent here that the back part 14 comprises a back cushion 70 and the seat part 16 comprises a seat cushion 72. In the case of the aircraft seat 12 shown on the left in FIG. 3, the seat cushion 72 is detached from the frame 20. Likewise, the back cushion 70 may also be detachably connected to a further part of the frame 20.

The seat cushion normally rests on a seat area 74 of the frame 20, which can be seen in the aircraft seat 12 shown on the left. For example, respective sensors 26 may be arranged between the seat cushion 72 and the seat area 74 of the frame 20. For example, however, the seat area 74 may also be configured as a seat trampoline, which preferably can also provide a certain degree of damping by means of elasticity at least in certain areas. In the area of a seat trampoline, the frame 20 therefore may also comprise a textile surface instead of a plastic or aluminum plate. This entails that a corresponding seat can be particularly light and space-saving. Advantageously, for the purpose of further weight saving, the textile area of the seat trampoline may be formed by a textile sensor so that the aircraft seat 12 of the seating system 10 is hardly or only slightly heavier than conventional seats.

Due to the detachable attachment of respective cushions of the aircraft seat 12, respective sensors 26 and thus the seating system 10 can be easily retrofitted in the case of existing interior equipment and in particular seat equipment of the passenger aircraft. Maintenance is thus also simplified.

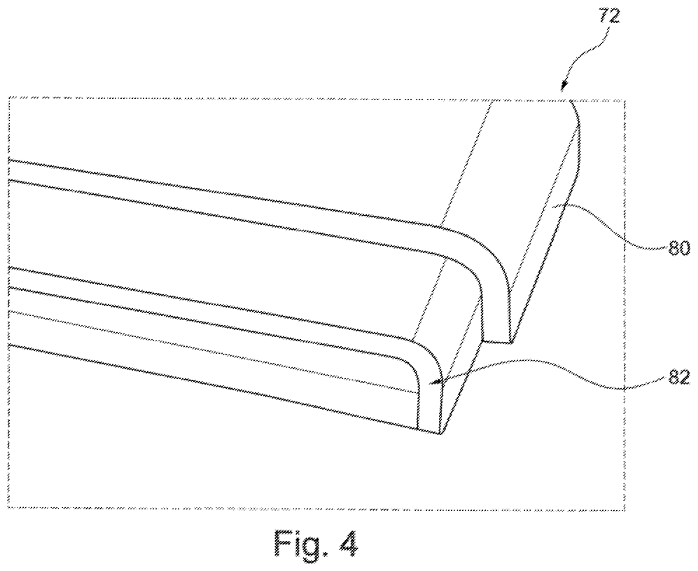

FIG. 4 is a schematic sectional view illustrating an exemplary layered structure of the seat cushion 72 of the aircraft seat 12. The seat cushion 72 comprises a cover layer 80 and a plurality of foam layers 82 as a core. The foam layers 82 mainly provide the seat damping, while the cover layer 80 encapsulates the core and protects it from environmental influences. Respective sensors 26 and also their connecting wires to the transmitting device 28 may be arranged in a recess in the core and/or also between the respective layers of the core of the seat cushion 72. Simple retrofitting and/or modification of existing seat cushion designs is thus easily possible. Alternatively, a surface sensor may also be provided as a respective additional layer between the foam layers 82 and/or the cover layer 80. Alternatively, the cover layer 80 itself may also be completely or partially formed by a sensor 26. A textile sensor is particularly suitable for this purpose. In this case, the seat load can be detected particularly precisely, since respective cushioning layers cannot dampen a pressure load, distribute it extensively and/or otherwise falsify it.

Aircraft seats 12 are among the most important comfort-relevant elements of any passenger aircraft since they are in direct contact with the passenger 22, and the passenger 22 spends most of his/her time during the air travel on the seat. Meanwhile, due to the modern long-haul aircraft, non-stop air travel of up to 18 hours can be conducted, in the case of which the passenger 22 for the most part is in the sitting position.

The seating system 10 enables the passenger 22 to receive feedback on his/her sitting behavior, in particular whether the sitting behavior is poor and/or unhealthy. The passenger 22 can be encouraged to sit more healthily, wherein the passenger 22 no longer has to laboriously control his/hers sitting posture himself/herself.

Due to the constant cost pressure, airlines are striving to reduce fuel consumption constantly, wherein weight savings in aircraft is a decisive criterion for reducing fuel costs. In this context, a great deal has also been saved in recent years on seats and seat foams, both in terms of weight and material. This resulted in that today's aircraft seats comprise a very thin layer of seat foam so that the spine and muscles of the passenger 22 are subjected to greater stress. An intelligent, self-monitoring sitting-posture control system, such as that realized by the seating system 10, is capable of relieving stress on the passenger's spine and muscles, inducing a more intense sense of well-being for the passenger 22 and bringing about a lasting better impression of the airline. As the case may be, even further material and weight savings are possible by means of an adapted sitting behavior. Therefore, respective recommendations of the seating system 10 may be adapted to the specific configuration of the aircraft seat 12, which, as the case may be, is more comfortable in certain sitting postures and/or wears more slowly than in other sitting postures. The therefore advantageous sitting postures may be preferably or exclusively recommended.

A lasting loyalty of the passenger 22 to the airline may be achieved in that also in the airline app the passenger 22 is shown his/her entire sitting behavior during his/her last flights, provided with tips and suggestions on how to strengthen his/her back muscles and informed about any improvements or deteriorations in his/her sitting posture in the course of the time. This can also be easily realized with the seating system 10, since the evaluation of the sitting behavior can already be carried out by means of the smartphone 34 of the passenger 22.

Furthermore, the seating system 10 may be used to control the seat occupancy. In turbulent flight phases, for example during turbulence, take-off and/or landing, respective flight attendants can remotely detect, for example via a special app and/or cabin control system, if a seat is abandoned despite instructions. In particular, when the seating system 10 is combined with the so-called “smart belt” of the company Aircraft Cabin Modification GmbH, reliable monitoring and tracking of the seat belt situation of a passenger 22 during the entire flight is possible. To this end, respective data on when an aircraft seat 12 was occupied can be compared with respective data on when a seat belt was fastened.

The seating system 10 may be modularly installed and/or retrofitted for respective aircraft seats of a passenger aircraft. The seating system 10 may provide a seat information system that detects an overview of the sitting posture of respective passengers, is capable of displaying it graphically and/or displaying the seat occupancy to respective flight attendants. The seating system 10 is therefore advantageous for health and safety reasons. It can reduce the health burden imposed by long-distance flights and reduce the workload for flight attendants as well as increase the safety on board.

To this end, an unambiguous signal, for example in the form of the electrical resistance of respective sensors 26, may be generated at the seating system 10, said unambiguous signal allowing conclusions to be drawn about the force transmission between the passenger 22 and respective surfaces of the aircraft seat 12, in particular its seat foam. The seating system 10 can deduce therefrom whether the air passenger has adopted a correct and/or healthy sitting posture. For this purpose, one or more sensors 26 may be provided that function, for example, mechanically or as an inductive proximity switch and are integrated in the seat foam. By means of measuring, e.g., the electrical resistance in the sensor 26, it can then be detected, for example, at which point of the aircraft seat 12 the passenger 22 currently has his/her center of gravity. For example, the resistance is low at a non-loaded area of the seat foam, whereas it is high at a loaded area. The seating system 10 and in particular individual components may be coupled to an in-flight entertainment system, in particular a seat-integrated in-flight entertainment system, which may also be referred to as infotainment system, for example for the purpose of data transmission and/or power supply. Parts of the in-flight entertainment system may also constitute parts of the seating system 10. For example, respective screens may function as display devices 32. Alternatively or additionally, the seating system 10 and in particular individual components may also be provided with an autonomous power supply, for example in the form of a button cell.

Alternatively or additionally, the seating system 10 and/or the evaluation device 32 may also be configured to ascertain how good the passenger 22 feels on the aircraft seat 12 depending on the detected seat load, the determined sitting posture, the history of the detected seat load, and/or the history of the determined sitting posture. These data may be used to further enhance the travel comfort. The data can be stored in a manner individually assigned to the passenger 22 and/or the aircraft seat 12. Improvements to the sense of well-being of the passenger 22 can thus be selectively initiated, and respective seats can be optimized and/or further developed or replaced with more comfortable seats. The sense of well-being of the passenger 22 on the aircraft seat 12 can be determined, for example, depending on how often the passenger 22 moves, how intensely the passenger 22 moves, in which way the passenger 22 moves, how often and/or how long the passenger 22 sleeps and/or how often the passenger 22 stands up. These data can also be stored for analysis.

### LIST OF REFERENCE SIGNS

10 Seating system
12 Aircraft seat
14 Back part
16 Seat part
18 Armrest
20 Frame
22 Passenger
24 Sensor device
26 Sensor
28 Transmitter device
30 Transmitter
32 Evaluation device
34 Smartphone r
36 Display device
38 Receiver
40 Joint
42 Joint
50 Flow diagram
52 Block
54 Block
56 Block
58 Block
60 Block
62 Block
70 Back cushion
72 Seat cushion
74 Seating area
80 Cover layer
82 Foam layers

1-20. (canceled)

21. A seating system for a passenger aircraft, comprising:
at least one aircraft seat having at least one sensor device which is configured to detect a seat load on the aircraft seat by a passenger sitting thereon;
an evaluation device which is configured to determine a recommendation for a change in a sitting posture depending on the detected seat load; and
a display device which is configured to display the recommendation,
wherein the sensor device is configured to record a temporal history of the detected seat load and the evaluation device is configured to determine a recommendation for a change in the sitting posture depending on the detected history of the seat load.

22. The seating system according to claim 21, wherein the evaluation device is configured to determine a sitting posture depending on the detected seat load.

23. The seating system according to claim 22, wherein the evaluation device is configured to determine the recommendation for the change in the sitting posture depending on the determined sitting posture.

24. The seating system according to claim 22, wherein the at least one display device is configured to graphically display the sitting posture determined by the evaluation device.

25. The seating system according to claim 21, wherein the evaluation device is configured to determine a temporal history of the sitting posture of the passenger depending on the detected temporal history of the detected seat load.

26. The seating system according to claim 25, wherein the evaluation device is configured to determine the recommendation for the change in the sitting posture depending on the detected temporal history of the sitting posture.

27. The seating system according to claim 25, wherein the display device is configured to display the temporal history of the determined sitting posture.

28. The seating system according to claim 21, wherein the recommendation for the change in the sitting posture comprises one or a combination of a change to another sitting posture, a change to a new sitting posture, a change to a predetermined sitting posture ascertained depending on a previous sitting posture of the passenger, leaving the seat, or a sequence of movements.

29. The seating system according to claim 21, wherein the sensor device comprises at least one sensor which is configured as a pressure sensor, which detects a force acting thereon by a change in a capacitance.

30. The seating system according to claim 29, wherein the sensor device is a textile surface sensor.

31. The seating system according to claim 21, wherein the sensor device comprises at least one sensor which is arranged in one or a combination of a back part, a seat part, or an armrest of the seat.

32. The seating system according to claim 21, further comprising a storage device which is configured to store one or a combination of the detected seat load, a determined sitting posture, the temporal history of the detected seat load, or a temporal history of the determined sitting posture.

33. The seating system according to claim 32, wherein the storage device is configured to store one or a combination of the detected seat load, the determined sitting posture, the temporal history of the detected seat load, or the temporal history of the determined sitting posture in a manner assigned to an individual passenger and/or a respective aircraft seat type.

34. The seating system according to claim 32, wherein the evaluation device is configured to determine how good the passenger feels on the aircraft seat depending on one or a combination of the detected seat load, the determined sitting posture, the temporal history of the detected seat load, or the temporal history of the determined sitting posture.

35. The seating system according to claim 34, wherein how good the passenger feels on the aircraft seat is determined depending on one or a combination of how often the passenger moves, how intensely the passenger moves, in which way the passenger moves, how often the passenger sleeps, how long the passenger sleeps, or how often the passenger stands up.

36. A method for operating a seating system for a passenger aircraft, comprising at least the steps of:
detecting a seat load of an aircraft seat by a passenger sitting thereon by means of a sensor device;
determining a recommendation for a change in a sitting posture of the passenger depending on the detected seat load; and
displaying the recommendation on a display device,
wherein a sitting posture of the passenger is determined depending on the seat load, a temporal history of the seat load is detected and the recommendation for the change in the sitting posture is determined depending on the determined sitting posture and the history of the seat load.

37. The method of claim 36, wherein the recommendation for the change in the sitting posture comprises one or a combination of a change to another sitting posture, a change to a new sitting posture, a change to a predetermined sitting posture ascertained depending on a previous sitting posture of the passenger, leaving the seat, or a sequence of movements.

38. A seating system for a passenger aircraft, comprising:
at least one aircraft seat having at least one sensor device which is configured to detect a seat load on the aircraft seat by a passenger sitting thereon;
a storage device which is configured to store the detected seat load, a determined sitting posture, a history of the detected seat load and/or a history of the determined sitting posture; and
an evaluation device which is configured to determine how good the passenger feels on the aircraft seat depending on the detected seat load, the determined sitting posture, the history of the detected seat load, and/or the history of the determined sitting posture.

39. The seating system for a passenger aircraft according to claim 38, wherein how good the passenger feels on the aircraft seat is determined depending on one or a combination of how often the passenger moves, how intensely the passenger moves, in which way the passenger moves, how often the passenger sleeps, how long the passenger sleeps, or how often the passenger stands up.

40. The seating system for a passenger aircraft according to claim 38, wherein the storage device is configured to store one or a combination of the detected seat load, the determined sitting posture, the history of the detected seat load, and/or the history of the determined sitting posture in a manner assigned to individual passengers and/or a respective aircraft seat type.
